(19) United States
(12) Patent Application Publication
(10) Pub. No.: US 2024/0206530 A1
(43) Pub. Date: Jun. 27, 2024

(54) Filter Comprising A Paper Substrate Modified With A Natural Polysaccharide

(71) Applicant: SWM Holdco Luxembourg, Contern (LU)

(72) Inventors: Raoul Herve, Spay (FR); Oxana Cherkas, Le Mans (FR); Diane Raverdy-Lambert, Le Mans (FR); Patrick Guilchet, Spay (FR); Thomas Blin, Spay (FR)

(21) Appl. No.: 18/390,870

(22) Filed: Dec. 20, 2023

(30) Foreign Application Priority Data
Dec. 27, 2022 (FR) 2214537

(51) Int. Cl. A24D 3/14; A24D 3/02; A24D 3/10; A24D 3/17; D21H 19/12; D21H 27/08

(52) U.S. Cl. CPC A24D 3/14; A24D 3/0212; A24D 3/10; A24D 3/17; D21H 19/12; D21H 27/08

(57) ABSTRACT

The present invention relates to a filter comprising a paper substrate modified by a natural polysaccharide.

### TECHNICAL FIELD

The invention provides a filter comprising a paper substrate modified with natural polysaccharide. This filter can be used as filter for a smoking or vaping article.

### BACKGROUND ART

A filter for a smoking or vaping article has a right circular cylindrical shape and generally comprises an outer envelope of plug wrap paper and a substrate located within the outer envelope. The filter for a smoking or vaping article, by virtue of the substrate, makes it possible to prevent the user from inhaling tobacco particles and allows retention of the harmful particulate substances contained in the smoke or the aerosol, such as tar.

Conventional filters comprise cellulose acetate tow. Said conventional filters are also known as cellulose acetate filters. The cellulose acetate filters have a nicotine retention capacity such that the user's perception of the filtered smoke is satisfactory. However, the cellulose acetate filters degrade very slowly and have negative impact on the environment. Indeed, the filter is not consumed during the smoking/vaping of a smoking/vaping article and is regularly found in the environment. Cellulose acetate filters thus have a significant environmental impact.

To limit the environmental impact of cellulose acetate filters, it has been proposed to replace the cellulose acetate tow with a paper substrate obtained by a wetlaid process or wetlace process. As the paper substrates are biodegradable, the filters comprising a paper substrate degrade rapidly. However, the filters comprising a paper substrate have higher filtration efficiency, in particular higher nicotine retention capacity, and lower hardness than cellulose acetate filters. Since the nicotine retention capacity is higher, then the perception of the filtered smoke by the user may not be satisfactory. Moreover, the filters comprising a paper substrate can collapse when used because of the lower hardness. Accordingly, the user's experience provided by the filters comprising a paper substrate is not as satisfactory as the user's experience provided by the cellulose acetate filters.

### TECHNICAL PROBLEM

There is therefore a need for a paper substrate which makes it possible to manufacture a filter having a nicotine retention capacity which tends towards the nicotine retention capacity of a cellulose acetate filter, and which has satisfactory mechanical properties thereby providing a satisfactory user experience.

It is thus to the credit of the inventors to have found that it was possible to meet this need by means of a paper substrate modified with a natural polysaccharide.

### SUMMARY

It is proposed a filter comprising a paper substrate, said paper substrate comprising:
a base web, and
a natural polysaccharide, in particular a cellulosic derivative, pullulan, chitosan, a pectin, an alginate, a gum, agar, a carrageenan or mixtures thereof, more particularly a cellulosic derivative, a pectin, an alginate, a gum or mixtures thereof, even more particularly a pectin, an alginate, a gum or mixtures thereof.

In comparison to standard paper filter, the nicotine retention capacity of the filter of the invention is advantageously improved as it tends towards the nicotine retention capacity of cellulose acetate filters.

Without wishing to be bound to any theory, the inventors are of the opinion that this improvement of the nicotine retention capacity by the filter of the present invention may be due to:
a decrease of the number of standing fibers on the surface of the paper substrate thanks to the natural polysaccharide bonding the fibers, and
the air permeability of the paper substrate of the filter of the present invention being lower than the air permeability of the standard paper substrate thanks to the natural polysaccharide.

The filter of the invention also has very satisfactory mechanical properties. In particular, it has higher hardness, and thus is more resistant to collapsing, than a filter comprising a standard paper substrate.

Without wishing to be bound to any theory, the inventors are of the opinion that the mechanical properties of the filter of the invention is due to the natural polysaccharide. Indeed, the natural polysaccharide enables the density of the paper substrate to be higher than the density of a standard paper substrate so that, for the same pressure drop, the density of the filter of the present invention is higher than the density of a filter comprising a standard paper substrate.

Further, in contrast to a cellulose acetate filter, the filter of the invention may, by virtue of its composition, degrade very rapidly in the environment. This is particularly advantageous, since the environmental impact of the filter of the invention is smaller than the environmental impact of a cellulose acetate filter.

According to another aspect, a process is proposed for producing a filter as defined above for a smoking or vaping article, comprising the following steps:
a) producing a base web by a wetlaid process or a wetlace process, in particular a wetlaid process,
b) applying the natural polysaccharide to the base web to produce a paper substrate,
c) forming a rod from the paper substrate produced in step b),
d) wrapping the rod with a sheet of plug wrap paper,
e) depositing an adhesive line at the junction of the sheet of plug wrap paper to obtain a rod of filtering material, and
f) cutting the rod of filtering material to produce the filter.

### DESCRIPTION OF EMBODIMENTS

It is proposed a filter comprising a paper substrate, said paper substrate comprising:
a base web, and
a natural polysaccharide, in particular a cellulosic derivative, pullulan, chitosan, a pectin, an alginate, a gum, agar, a carrageenan or mixtures thereof, more particularly a cellulosic derivative, a pectin, an alginate, a gum or mixtures thereof, even more particularly a pectin, an alginate or mixtures thereof.

The term “base web” is used herein to mean a fibrous sheet.

The term “natural polysaccharide” means a natural carbohydrate made of a large number of monosaccharides linked together by glycosidic bonds. The natural polysaccharide can have vegetal or microbiologic origin.

The base web is conventionally used for manufacturing filters for smoking or vaping articles. The skilled person thus knows how to obtain the base web having the properties required to produce the paper substrate having the required properties. Moreover, the base web is obtainable by a wetlaid process or wetlace process, in particular by a wetlaid process. Accordingly, the paper substrate of the filter of the invention is obtainable by a wetlaid process or wetlace process, in particular by a wetlaid process.

Typically, the base web may comprise more than 50 wt. % of wood fibers, in particular 100 wt % of wood fibers.

Wood fibers may be hardwood pulp, bleached hardwood pulp, softwood pulp, bleached softwood pulp, softwood fluff pulp, lyocell fibers (cellulose fibers which are ground and dissolved in N-methylmorpholine N-oxide monohydrate for the purpose of obtaining fibers with a cross section of variable shape (round, oval, cross-shaped, circular, lamellar cross section) with calibrated length and mass per unit length, which the person skilled in the art can choose depending on their needs), viscose fibers (fibers obtained by dissolving cellulose by means of modification of its hydroxyl groups by carbon disulfide (CS₂) and then precipitating it in the presence of sulfuric acid (H₂SO₄) for the purpose of obtaining fibers with a cross section of variable shape (round, oval, cross-shaped, circular, lamellar cross section) with calibrated length and mass per unit length, which the person skilled in the art can choose depending on their needs) or mixtures thereof, in particular bleached softwood pulp, softwood pulp, softwood fluff pulp, lyocell fibers, viscose fibers or mixtures thereof, more particularly bleached softwood pulp, softwood pulp, softwood fluff pulp or mixtures thereof.

The base web may further comprise natural fibers such as leaf fibers, fruit fibers, seed fibers, bast fibers, stalk fibers, reed fibers or mixtures thereof, in particular leaf fibers, seed fibers, bast fibers or mixtures thereof, more particularly bast fibers.

For the purposes of the present application, “bast fiber” denotes a plant fiber contained in the bast of the plants.

The bast fibers may be abaca fibers, hemp fiber, Indian hemp fiber, jute fiber, kenaf fiber, kudzu fiber, coin vine fiber, flax fiber, okra fiber, nettle fiber, papyrus fiber, ramie fiber, sisal fiber, esparto fiber or mixtures thereof, in particular hemp fiber, flax fiber, sisal fiber or mixtures thereof, more particularly flax fiber, sisal fiber, or mixtures thereof.

For the purposes of the present application, “seed fiber” denotes a fiber obtained from seeds of a plant. The seed fibers may be cotton fiber, kapok fiber, luffa fiber, milkweed fiber or mixtures thereof.

According to the present invention, the natural polysaccharide is not starch or a derivative of starch, such as a modified starch. Indeed, the inventors noticed that starch may be altered during storing so that it gives non-satisfactory organoleptic properties during the smoking or the vaping. Additionally, starch is more difficult to process as it requires step of cooking during the manufacturing of the paper substrate.

The natural polysaccharide can be a derivative of natural polysaccharide, i.e. a natural polysaccharide that is modified using any modification known in the art. The derivative of natural polysaccharide may be a physically modified natural polysaccharide, a chemically modified natural polysaccharide, or mixtures thereof.

The cellulosic derivative is an example of derivative of natural polysaccharide. The cellulosic derivative can be methylcellulose, hydroxypropyl cellulose, carboxymethyl cellulose or mixtures thereof, in particular carboxymethyl cellulose.

The pectin can be low methoxy pectin, high methoxy pectin, amidated pectin or mixtures thereof, in particular low methoxy pectin, amidated pectin or mixtures thereof.

The alginate can be sodium alginate, calcium alginate or mixtures thereof. The alginate can have different mannuronate and guluronate ratios. In particular, the alginate can be sodium alginate with different mannuronate and guluronate ratios.

The gum can be arabic gum, gum acacia, xanthan gum, guar gum, gellan gum, ghatti gum, pullulan gum, mannan gum, or mixtures thereof, in particular guar gum.

The natural polysaccharide may be present in an amount of from 0.5% to 20% by weight of the base web, in particular of from 0.75% to 10% by weight of the base web, more particularly of from 1% to 5% by weight of the base web.

In comparison to standard paper filter, the nicotine retention capacity of the filter of the invention having the natural polysaccharide in these ranges is advantageously improved as it tends towards the nicotine retention capacity of cellulose acetate filters.

Moreover, the mechanical properties, in particular hardness and collapse resistance, of the filter of the invention having the natural polysaccharide are better that the mechanical properties of standard paper filter.

The natural polysaccharide can be applied to the base web by means of different saturation or impregnation processes (as discussed in more details below). Accordingly, the natural polysaccharide may form a layer on one or more surfaces of the base web, may partially penetrate into the base web, may fully penetrate into the base web or combinations thereof, in particular combinations thereof.

The term “saturation” and “impregnation” have the meaning commonly known in the art, they are synonyms and can be interchangeably used to indicate the application of a natural polysaccharide to the base web so that the natural polysaccharide forms a layer on one or more surfaces of the base web, partially penetrates into the base web, fully penetrates into the base web or combinations thereof, in particular combinations thereof.

The paper substrate may further comprise additives commonly used in filter for a smoking or vaping article.

The air permeability of the paper substrate may be of from 350 CORESTA Unit (CU) to 3550 CU, in particular of from 1000 CU to 3250 CU, more particularly of from 2000 CU to 3000 CU.

The lower value of the air permeability may be reached by paper substrate which has been calendered.

An air permeability as defined above is lower than the air permeability of a paper substrate used in the standard paper filters, i.e. about 3600 CU. Advantageously, the filter of the present invention comprising a paper substrate with an air permeability within these ranges of value has better nicotine retention capacity than the standard paper filters.

The air permeability of the paper substrate can be determined by ISO 2965:2009. The paper substrate can be conditioned for at least 30 min at 23° C. and 50% humidity before the measurement.

The density of the paper substrate may, for example, be higher than 431 mg/cm³, in particular of from 431 mg/cm³ to 600 mg/cm³, more particularly of from 433 mg/cm³ to 500 mg/cm³, even more particularly of from 435 mg/cm³ to 465 mg/cm³.

A density within these ranges of value is higher than the density of a paper substrate used in the standard paper filters, i.e. about 429 mg/cm³. The filter of the present invention comprising a paper substrate with a density within these ranges of value has, advantageously, higher mechanical properties, in particular hardness and collapse resistance, than a filter comprising a standard paper substrate. The inventors are of the opinion that the hardness of filter is improved because the higher the paper density, the higher the filter density.

The density of the paper substrate is calculated by dividing its basis weight by its thickness.

The standard ISO 536:2012 can be used to determine the basis weight of the paper substrate. The paper substrate can be conditioned for at least 30 min at 23° C. and 50% humidity before the measurement.

The standard ISO 534:2011 can be used to determine the thickness of paper substrate. The measurements were performed on one layer. The paper substrate can be conditioned for at least 30 min at 23° C. and 50% humidity before the measurement.

The skilled person knows how to adapt the basis weight and the thickness of the paper substrate to reach the required density.

For instance, the basis weight of the paper substrate may be of from 10 g.m⁻² to 60 g.m⁻², in particular of from 20 g.m⁻² to 50 g.m⁻², more particularly of from 26 g.m⁻² to 40 g.m⁻².

The thickness of the paper substrate may be of from 30 μm to 250 μm, in particular of from 37 μm to 150 μm, more particularly of from 40 μm to 100 μm.

In some circumstances, the paper substrate may have a density of from 445 mg/cm³ to 465 mg/cm³, an air permeability of from 2000 CU to 3000 CU, a basis weight of from 26 g.m⁻² to 40 g.m⁻², and a thickness of from 80 μm to 100 μm and the natural polysaccharide can be a pectin, a guar gum or mixtures thereof.

The paper substrate of the filter of the invention can be shaped; in particular, it can be crimped, embossed, folded, compressed. This shaping can make it possible to modify the properties of the paper substrate and therefore the properties of the filter of the invention. For example, through crimping, it is possible to modify the density of the paper substrate, and thus to increase or reduce the pressure drop of the filter of the invention without changing the weight of the filter.

The filter of the present invention may be a filter for a smoking or vaping article.

For the purposes of the present application, “smoking article” denotes an article comprising tobacco and/or any other plant intended to be smoked. For example, the smoking article may be a machine-manufactured cigarette, a roll-your-own cigarette or a make-your-own cigarette.

Typically, the filter for a smoking article has a right circular cylindrical shape and comprises an outer envelope of plug wrap paper for a smoking article, in particular for a cigarette, and the paper substrate as defined above located within the outer envelope.

For the purposes of the present application, “vaping article” denotes an article comprising tobacco and/or any other plant intended to be vaped, which is intended to be inserted into a device which heats the tobacco and/or the plant without burning said tobacco/plant and which enables delivery of an aerosol to a user. For example, the vaping article can be a tobacco stick.

Typically, the filter for a vaping article has a right circular cylindrical shape and comprises an outer envelope of plug wrap paper for a vaping article, in particular for a tobacco stick, and the paper substrate as defined above located within the outer envelope.

The filter of the invention can have a density of from 135 mg/cm³ to 350 mg/cm³, in particular of from 200 mg/cm³ and 280 mg/cm³, more particularly between 220 mg/cm³ and 265 mg/cm³.

Typically, the density of the filter is measured after manufacture of the filters, by dividing the mass of the filter by its volume. For a filter having a right circular cylindrical shape, the volume of the filter (V_{filter}) is calculated by the following formula: V_{filter}=π*L*r², in which r denotes the radius of the filter and L denotes the length of the filter.

The density of the filter of the invention is higher than the density of the standard paper filters. Without wishing to be bound to any theory, the inventors are of the opinion that the mechanical properties of the filter of the invention, in particular its hardness and its collapse resistance, are due to the high density of the filter of the invention.

The filter of the invention can comprise:
an outer envelope of plug wrap paper for a filter for a smoking or vaping article, and
the paper substrate within the outer envelope.

The filter of the invention can have a right circular cylindrical shape.

According to another aspect, the present invention also relates to a smoking article comprising a filter as defined above.

According to another aspect, the present invention also relates to a vaping article comprising a filter as defined above.

The present invention also relates to a process for producing a filter as defined above for a smoking or vaping article, comprising the following steps:
a) producing a base web by a wetlaid process or a wetlace process, in particular a wetlaid process,
b) applying the natural polysaccharide to the base web to produce a paper substrate,
c) forming a rod from the paper substrate produced in step b),
d) wrapping the rod with a sheet of plug wrap paper,
e) depositing an adhesive line at the junction of the sheet of plug wrap paper to obtain a rod of filtering material, and
f) cutting the rod of filtering material to produce the filter.

The paper substrate, the base web and the natural polysaccharide are as defined above.

The wetlaid process and the wetlace process are conventional processes known to the skilled person. The skilled person knows how to adapt the parameters of these processes to produce the base web during step a).

During step b), the natural polysaccharide is applied to the base web by means of different saturation or impregnation processes (as discussed in more details below). Accordingly, the natural polysaccharide may form a layer on one or more surfaces of the base web, may partially penetrate into the base web, may fully penetrate into the base web or combinations thereof, in particular combinations thereof.

Step b) of applying may be performed by size press, film press, saturator, dip coating, bar coating, knife coating, flexography, spraying or combinations thereof, in particular by film press, spraying, size press or combinations thereof, more particularly by size press.

These processes to apply the natural polysaccharide are well known by the skilled person. Accordingly, the skilled person knows how to adapt the parameters of these processes to produce the paper substrate.

The base web produced in step a), the paper substrate produced in step b) or both can be shaped.

Therefore, the process may comprise, between step a) and step b), a step of shaping the base web by crimping, embossing, folding, compression or combinations thereof. The inventors are of the opinion that the natural polysaccharide application after the crimping may reduce the number of standing fibers generated during the crimping.

Alternatively, or additionally, the process may comprise, between step b) and step c), a step of shaping the paper substrate by crimping, embossing, folding, compression or combinations thereof. The inventors are of the opinion that the natural polysaccharide application before the crimping may bind the fibers between them and thus limit the generation of standing fibers during the crimping.

Steps c) to e) are steps well known to the skilled person. The skilled person knows how to adapt the parameters of these processes to produce the filter of the invention.

### EXAMPLES

### Example 1: Paper Substrate Manufacturing

A base web was produced with bleached softwood fibers by a wetlaid process.

The base web has a density of 429 mg/cm³, a basis weight of 36 g/m², a thickness of 84 μm and a permeability of 3300 CU.

The base web was cut into 4 different parts.

Each part was impregnated with a natural polysaccharide by a film press to produce a paper substrate.

The properties of these different paper substrates are presented in Table 1 below as Example 1.1 to 1.4.

### Example 2: Filter Manufacturing

Filters for a smoking article were manufactured with a nonporous plug wrap paper having a basis weight of 23.5 g/m² as an outer envelope and the substrates of Examples 1.1 to 1.4 by a standard method for manufacturing filters by crimping.

A filter for a smoking article was manufactured with a nonporous plug wrap paper having a basis weight of 23.5 g/m² as an outer envelope and the base web produced in Example 1 (referred as Comparative paper filter in Table 2 below).

The properties of these five filters were compared with the properties of a commercial cellulose acetate filter from Marlboro Red France™.

The filter hardness was measured by a standard method by use a Filtrona DHT200 equipment. Results are expressed at % of crushing versus initial diameter of filter.

The characteristics of the filters are given in Table 2 below.

Table 2 demonstrates that the filters according to the invention have:
higher hardness than hardness of the Comparative paper filter, and
hardness of the same magnitude of order or higher than the hardness of the commercial cellulose acetate filter.

### Example 3: Manufacture and Characterization of Cigarettes

Cigarettes were prepared using the filters rods described in Example 2. The filters were cut to 21 mm length. To form the cigarettes, the rods of tobacco were assembled with the cut filters using nonporous 35 g/m² tipping paper. A commercial “American blend” tobacco was used to form the rods of tobacco. The cigarettes were prepared with a pressure difference similar to that of the commercial cigarette. The ventilation of the cigarettes was blocked.

The cigarettes prepared were smoked on a Borgwaldt RM20 smoking machine in accordance with the standard ISO 3308:2000.

The pressure drop (PD in Table 3 below) was measured in accordance with the standard ISO 6565:2002.

The nicotine content in the smoke after the filter is determined as follows:
the nicotine content in the smoke produced by 10 smoked cigarettes was measured in accordance with the standard ISO 10315:2000. This nicotine content is then divided by 10 to calculate the nicotine content in the smoke produced by one smoked cigarette.
this process is performed 3 times to calculate 3 nicotine contents in the smoke produced by one smoked cigarette.
   The nicotine content in the smoke after the filter is the average of these 3 nicotine contents in the smoke produced by one smoked cigarette.

The “Nicotine retention” value is calculated according to the following formula:

$$Nicotine retention ( \% ) = \frac{CNAF 1 - CNACAF}{CNACAF} \times 100 ,$$

wherein
CNAF1 is the content of nicotine in the smoke after the filter comprising the paper substrate (in mg), and
CNACAF is the content of nicotine in the smoke after the commercial cellulose acetate filter (in mg).

The smoking results are given in Table 3 below.

Table 3 demonstrates that, with an equivalent pressure drop, the difference between the nicotine retention of the cigarettes with the filters according to the invention and the nicotine retention of the cigarettes with the commercial cellulose acetate filter is lower than the difference between the nicotine retention of the cigarette with the conventional paper filter and the nicotine retention of the cigarettes with the commercial cellulose acetate filter.

TABLE 1

| | | Paper substrate of | Paper substrate of | Paper substrate of | Paper substrate of |
|---|---|---|---|---|---|
| | Base web | Example 1.1 | Example 1.2 | Example 1.3 | Example 1.4 |
| Natural | / | Guar gum a | Amidated | Low methoxy | Low methoxy |
| polysaccharide | | | pectin b | pectin c | pectin c |
| Amount of natural | / | 3 | 3 | 3 | 5 |
| polysaccharide | | | | | |
| (% by weight of | | | | | |
| the base web) | | | | | |
| Density | 429 | 453 | 462 | 450 | 485 |
| (mg/cm³) | | | | | |
| Basis weight | 36 | 37.3 | 37.3 | 37.2 | 38 |
| (g · m⁻²) | | | | | |
| Thickness | 84 | 82 | 81 | 83 | 78 |
| (μm) | | | | | |
| Permeability | 3600 | 2064 | 2419 | 2606 | 2130 |
| (CU) | | | | | |

a: Polygal 2230 from POLYGAK AG
b: Vivapur LA-S20 from J. Rettenmaier & Sohne GmbH
c: Vivapur LC-S12X from J. Rettenmaier & Sohne GmbH

TABLE 2

| | Commercial | | Filter with | Filter with | Filter with | Filter with |
|---|---|---|---|---|---|---|
| | cellulose acetate | Comparative | substrate of | substrate of | substrate of | substrate of |
| | filter | paper filter | Example 1.1 | Example 1.2 | Example 1.3 | Example 1.4 |
| Filter length (mm) | 120 | | | | | |
| Filter diameter (mm) | 7.8 | | | | | |
| Filter density (mg/cm³) | 139 | 223 | 261 | 262 | 255 | 270 |
| Filter hardness (%) | 95 | 92 | 94 | 95 | 96 | 97 |

TABLE 3

| | Commercial | | Filter with | Filter with | Filter with | Filter with |
|---|---|---|---|---|---|---|
| | cellulose acetate | Comparative | substrate of | substrate of | substrate of | substrate of |
| | filter | paper filter | Example 1.1 | Example 1.2 | Example 1.3 | Example 1.4 |
| Cigarette PD (mmWG) | 104 | 100 | 100 | 101 | 105 | 108 |
| Nicotine retention | 0 | −41 | −37 | −25 | −30 | −26 |
| (difference vs | | | | | | |
| commercial cellulose | | | | | | |
| acetate filter in %) | | | | | | |

1. A filter comprising a paper substrate, said paper substrate comprising:
a base web, and
a natural polysaccharide.

2. Filter according to claim 1, wherein the natural polysaccharide is a cellulosic derivative, pullulan, chitosan, a pectin, an alginate, a gum, agar, a carrageenan or mixtures thereof.

3. Filter according to claim 1, wherein the natural polysaccharide is present in an amount of from 0.5% to 20% by weight of the base web.

4. Filter according to claim 1, wherein the paper substrate has an air permeability of from 350 CU to 3550 CU.

5. Filter according to claim 1, wherein the paper substrate has a density higher than 431 mg/cm³.

6. Filter according to claim 1, wherein the paper substrate has a basis weight of from 10 g.m⁻² to 60 g.m⁻².

7. Filter according to claim 1, wherein the paper substrate is obtainable by a wetlaid process or a wetlace process.

8. Filter according to claim 1 for a smoking or vaping article.

9. Smoking article comprising a filter as defined in claim 8.

10. Vaping article comprising a filter as defined in claim 8.

11. Process to produce a filter for a smoking or vaping as defined in claim 8, comprising the following steps:
a) producing a base web by a wetlaid process or a wetlace process,
b) applying the natural polysaccharide to the base web to produce a paper substrate,
c) forming a rod from the paper substrate produced in step b),
d) wrapping the rod with a sheet of plug wrap paper,
e) depositing an adhesive line at the junction of the sheet of plug wrap paper to obtain a rod of filtering material, and
f) cutting the rod of filtering material to produce the filter.
